(19) United States
(12) Patent Application Publication
(10) Pub. No.: US 2009/0244248 A1
(43) Pub. Date: Oct. 1, 2009

(54) INKJET RECORDING MEDIUM AND METHOD OF MANUFACTURING THE SAME

(75) Inventors: Ryoichi Nakano, Fujinomiya-shi (JP); Hideki Kaimoto, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/410,070

(22) Filed: Mar. 24, 2009

(30) Foreign Application Priority Data
Mar. 26, 2008 (JP) 2008-081820

(51) Int. Cl. B41J 2/01; B05D 1/00

(52) U.S. Cl. 347/105; 427/209

(57) ABSTRACT

An inkjet recording material is provided which is capable of suppressing the generation of change in color tone (color change) of an image even when image-recorded surfaces are in contact with each other. The inkjet recording material includes: a support; and an ink-receiving layer including inorganic fine particles, a water-soluble resin and a water-soluble aluminum compound and provided on both sides of the support. A method of manufacturing the inkjet recording material is also provided.

### CROSS-REFERENCE TO RELATED APPLICATION

This application claims priority under 35 USC 119 from Japanese Patent Application No. 2008-081820, the disclosure of which is incorporated by reference herein.

### BACKGROUND OF THE INVENTION

### Field of the Invention

The present invention relates to an inkjet recording medium and a method of manufacturing the same.

With recent rapid advances in information technology, various types of information processing systems have been developed, and recording methods and recording devices suitable for the respective information processing systems have been put to practical use. Among these, inkjet recording methods have been widely used because it is possible to record on various kinds of recording materials thereby, the hardware (devices) is relatively cheap and compact and the methods are favorably quiet in operation. Furthermore, in recording that uses an inkjet recording method, it has become possible to obtain “photograph-like” high quality recorded matter.

A recording material for inkjet recording is generally required to have characteristics including (1) quick-drying property (high absorption speed of ink), (2) an adequate and uniform dot diameter (free from blurring), (3) excellent granularity, (4) high dot sphericity, (5) high color density, (6) high color saturation (no dullness), (7) excellent water resistance, weather resistance and ozone resistance of an image portion, (8) high whiteness, (9) high storage stability (free from yellowing and blurring of an image during long-term storage), (10) resistance to deformation; that is, high dimensional stability (low curling) and (11) excellent hardware operability.

In view of the above, a recording material in which an ink-receiving layer has a porous structure has been put to practical use in recent years. It is said that such a recording material has excellent quick-drying property and high glossiness. However, higher quality is always demanded for recorded images. Therefore, it is important, in addition to the quick-drying property and glossiness, that color change (for example, change in color tone) of the recorded images does not occur, and that the image quality does not suffer from deterioration by the generation of bleeding, bronzing of the image or the like.

In relation with the foregoing, an inkjet recording medium in which a water-soluble polyvalent metal salt contained in an ink-receiving layer is not uniformly distributed has been disclosed as an inkjet recording medium intended to reduce bleeding, improve color developability, and suppress bronzing (see, for example, Japanese Patent Application Laid-Open (JP-A) Nos. 2006-110771 and 2002-160442).

Further, an inkjet recording medium having an ink-receiving layer on both surfaces of a support has been disclosed (see, for example, JP-A Nos. 2005-349797, 2006-159755, and 8-11422). It is described in these documents that curling, or deterioration of transportability or visibility due to strike-through of an ink can be prevented.

However, the inkjet recording media having the ink-receiving layer on both surfaces of the support described in JP-A Nos. 2005-349797, 2006-159755 and 8-11422 are problematic in that color change is generated in an image due to direct contact between image-recorded surfaces.

### SUMMARY OF THE INVENTION

The present invention intends to provide an inkjet recording material capable of suppressing changes in color tone (color change) of an image even when image-recorded surfaces contact each other, and a method of manufacturing the inkjet recording material.

That is, according to an aspect of the invention, an inkjet recording material includes:

a support; and

an ink-receiving layer including inorganic fine particles, a water-soluble resin and a water-soluble aluminum compound and provided on both sides of the support.

According to another aspect of the invention, a method of manufacturing an inkjet recording material, includes:

preparing at least two coating solutions for forming an ink-receiving layer, the at least two coating solutions each including inorganic fine particles and a water-soluble resin, and at least one of the at least two coating solutions further including a water-soluble aluminum compound; and

layer-coating the at least two coating solutions for forming an ink-receiving layer on both sides of a support in such a manner that, when the thickness of an ink-receiving layer is regarded as 100%, the water-soluble aluminum compound is distributed such that the peak of the distribution of the water-soluble aluminum compound is present in a region from 20% to 60% from a surface of the ink-receiving layer at a side distant from the support.

### DETAILED DESCRIPTION OF THE INVENTION

According to an exemplary embodiment of the invention, an inkjet recording material is provided which is capable of suppressing the generation of change in color tone (color change) of an image even when image-recorded surfaces are in contact with each other. A method of manufacturing the inkjet recording material is also provided.

An inkjet recording medium according to an exemplary embodiment of the invention includes a support and ink-receiving layers provided on both surfaces of the support, respectively. Each of the ink-receiving layers includes at least one inorganic fine particle, at least one water-soluble resin, and at least one water-soluble aluminum compound. With such a constitution, generation of color change in an image may be suppressed even when image-recorded surfaces are in contact with each other. Particularly, since images can be recorded on both surfaces of the inkjet recording medium, generation of change in color tone may be suppressed effectively when plural inkjet recording media on which images have been recorded are stacked.

In the inkjet recording medium of the exemplary embodiment, when the thickness of an ink-receiving layer is regarded as 100%, the surface of the ink-receiving layer on the side distant from the support (i.e., the side not facing the support, hereinafter also referred to as the “outer surface”) is regarded as 0%, and the opposite surface of the ink-receiving layer on the side closer to the support (i.e., the side facing the support) is regarded as 100%. In such an inkjet recording medium, the peak of the distribution of a water-soluble aluminum compound included in the ink-receiving layer is preferably present at a depth (in a region), in the thickness direction of the ink-receiving layer, of from 20% to 60%, and more preferably at a depth (in a region) of from 40% to 55%, from the surface of the ink-receiving layer on the side distant from the support. When the peak of the distribution of the water-soluble aluminum compound is present at a position of 20% or deeper from the surface of the ink-receiving layer on the side distant from the support, generation of bronzing can be suppressed effectively. When the peak is present at a position of 60% or closer to the side distant from the support, change in color tone due to contact between image-recorded surfaces to each other can be suppressed more effectively, whereby the occurrence of age-induced bleeding can be suppressed effectively.

When the peak of the distribution of the water-soluble aluminum compound is present in the region described above, the peak position of the water-soluble aluminum compound in the depth direction (thickness direction) of the ink-receiving layer may be controlled by forming an ink-receiving layer including two or more ink-receiving sublayers, and appropriately considering the concentration of the water-soluble aluminum compound in each of the ink-receiving sublayers, the ratio of the number of layers or the ratio of the thickness between an ink-receiving layer containing the water-soluble aluminum compound and an ink-receiving layer not containing the water-soluble aluminum compound, and the position of the ink-receiving sublayer containing the water soluble-aluminum compound in the entire ink-receiving layer.

When the ink-receiving layer includes plural ink-receiving sublayers, the depth (position) of the peak of the distribution of the water-soluble aluminum compound from the outer surface of the ink-receiving layer can be defined with reference to the position of the center in the thickness direction of a sublayer having the largest amount of the water-soluble aluminum compound among the sublayers. Specifically, in a case of an inkjet recording medium in which only two or three ink-receiving layers are arranged on a support, the depth of the peak of the distribution of the water-soluble aluminum compound from the outer surface of the ink-receiving layer can be determined as described below.

For example, in a case where three ink-receiving sublayers include, for example, an uppermost layer including a water-soluble aluminum compound at a concentration of “a” (ink-receiving sublayer most distant from the support), an intermediate layer including a water-soluble aluminum compound at a concentration of “b”, and a lower layer including a water-soluble aluminum compound at a concentration of “c”, and where the relationship of the concentrations is as follows: “b”>“a”>“c”, the phrase “peak of the distribution of the water-soluble aluminum compound is present at a depth (in a region) of from 20% to 60% from the surface of the ink-receiving layer most distant from the support (in this case, the exposed surface of the outermost layer) in the thickness direction of the ink-receiving layer” means that the distance, in the thickness direction of the entire ink-receiving layer, from the exposed surface of the outermost layer to a position at one-half the thickness of the intermediate layer having the highest concentration of the water-soluble aluminum compound, is from 20% to 60% in the thickness direction of the entire ink-receiving layer from the exposed surface.

Further, for example, in a case where two ink-receiving sublayers are formed with an upper layer not containing the water-soluble aluminum compound (outermost layer) and a lower layer containing the water-soluble aluminum compound at a concentration of “d”, the phrase “peak of the distribution of the water-soluble aluminum compound is present at a depth of from 20% to 60% from the surface of the ink-receiving layer most distant from the support (exposed surface of the outermost layer) in the thickness direction of the ink-receiving layer” means that the distance from the exposed surface of the upper layer to a position at one-half the thickness of the lower layer containing the water-soluble aluminum compound, in the thickness direction of the entire ink-receiving layer, is from 20 to 60% in the thickness direction of the entire ink-receiving layer from the exposed surface.

The distribution of the water-soluble aluminum compound included in the ink-receiving layer can be measured by a general method in which a cross section of the entire ink-receiving layer disposed on a support is taken along a plane perpendicular to the support and the cross section is subjected to analysis using an energy dispersive fluorescent X-ray analyzer (SEM-EDX) attached to a scanning electron microscope (SEM). A SEM-EDX can be selected properly from apparatuses used generally. Specifically, the distribution is measured as described below by using JSM-6700 manufactured by JEOL Ltd. and GENESIS manufactured by EDAX Japan Co.

First, a cross section sample obtained by cutting the ink-receiving layer as described above is subjected to sputtering to apply a platinum film having a thickness of about 3 nm. After the sample is observed with an SEM (at 20 kV acceleration voltage), the entire thickness of the ink-receiving layer from the outermost surface of the ink-receiving layer to the support in the thickness direction of the layer is scanned while the amount of electron beam current is controlled to a predetermined value, and the spectrum of the sample is then obtained by performing X-ray scanning for 100 sec. From the spectrum, the distribution of the water-soluble aluminum compound and the peak thereof are determined.

The thickness of the ink-receiving layer included in the inkjet recording medium of the invention is preferably from 15 μm to 60 μm, and more preferably from 25 μm to 50 μm, from the viewpoint of suppressing bronzing and suppressing bleeding and change in color tone (change of color) of a recorded image.

Further, when the inkjet recording medium has two or more ink-receiving sublayers on one side of the support, the thickness of each layer is preferably from 5 μm to 25 μm and more preferably from 7 μm to 20 μm.

In the invention, it is particularly preferred that the thickness of the ink-receiving layer is from 25 μm to 50 μm, and that the peak of the distribution of the water-soluble aluminum compound included in the ink-receiving layer (all the ink-receiving sublayers) is present at a depth of from 20% to 60%, and preferably from 40% to 55%, from the surface of the ink-receiving layer on the side distant from the support in the thickness direction of the ink-receiving layer.

Hereinafter, components such as the inorganic fine particles, the water-soluble resin, and the water-soluble aluminum compound, which are included in the ink-receiving layer, are described in detail.

Inorganic Fine Particles

The ink-receiving layer in the invention includes at least one inorganic fine particle.

Examples of the inorganic fine particle include silica particles, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina particle, aluminum silicate, calcium silicate, magnesium silicate, zirconium oxide, zirconium hydroxide, cerium oxide, lanthanum oxide, and yttrium oxide. Among them, silica particles, alumina particles or pseudo-boehmite are preferred, silica particles are more preferred, and vapor phase silica is particularly preferred, from the viewpoint of forming an excellent porous structure.

Fine particles may be used as primary particles as they are, or secondary particles thereof may be used. The average primary particle diameter of the fine particles is preferably 2 μm or less, and more preferably 200 nm or less.

The silica particles can be classified generally into vapor phase silica and wet process silica depending on the manufacturing method thereof.

The vapor-phase process silica is also referred to as “dry process silica”. The dry process silica is generally produced by a flame hydrolysis process. More specifically, a process of producing the dry silica is generally known in which silicon tetrachloride is burned together with hydrogen and oxygen. Meanwhile, instead of using silicon tetrachloride, it is also possible to produce a dry process silica by using alone a silane compound such as methyltrichlorosilane or trichlorosilane, or by using a mixture of such a silane compound with silicon tetrachloride. The vapor-phase process silica is marketed and available from NIPPON AEROSIL Co., Ltd. under the trade name of AEROSIL and from TOKUYAMA Corporation under the registered name of REOLOSIL® QS series.

The average primary-particle size of the vapor-phase process silica is preferably from 5 nm to 50 nm. In order to achieve higher glossiness, a vapor-phase process silica is used which has an average primary-particle size of from 5 nm to 20 nm and a specific surface area of from 90 to 400 m²/g as determined by the BET method.

The BET (Brunauer, Emmett, Teller) method is one of methods for determining surface areas of fine particles by use of a gas-phase adsorption method, and is a method of determining the total surface area of fine particles included in 1 g of a sample (i.e., the specific surface area of fine particles in a sample) from an adsorption isotherm line. In the BET method, the gas used for adsorption in many usual cases is nitrogen gas, and a method is most frequently used in which the amount of an adsorbed gas is determined in accordance with a change in pressure or volume of the gas to be adsorbed. The most famous equation expressing the isotherm line of multilayer molecular adsorption is the

Brunauer-Emmett-Teller equation referred to as the BET equation, and widely used for determination of a surface area. The surface area is obtained by determining the amount of adsorbed gas based on the BET equation and multiplying the amount by the area that one adsorbed molecule occupies on a particle surface.

The vapor-phase process silica is present in a state that primary particles having sizes of several to several tens nanometers are secondarily flocculated by forming a reticular structure or being linked to one another to form chains. It is appropriate that these flocculated particles (secondary particles) be dispersed until the average particle size thereof reaches 500 nm or less, and preferably 300 nm or less. The lower limit of the size of the secondary particles is about 50 nm. Herein, the average particle size of the flocculated particles can be determined by photography with a transmission electron microscope. Alternatively, the average particle size can be determined simply and easily as a number median diameter by use of a laser scattering particle size distribution analyzer (e.g., LA910, trade name, manufactured by Horiba, Ltd.).

The silica products manufactured by wet processes can be further classified into precipitation process silica, gel process silica and sol process silica, according to their manufacturing methods. The precipitation process silica can be manufactured by reaction between sodium silicate and sulfuric acid under an alkaline condition. Silica particles grown in a manufacturing process are flocculated and precipitated; and then subjected to filtration, washing with water, drying, grinding and classification in sequence. Since the secondary particles of silica manufactured by this process are in a gently flocculated state, the secondary particles are relatively easily ground. The precipitation process silica is commercially available, e.g., from TOSOH SILICA CORPORATION under the trade name of NIPSIL or from TOKUYAMA Corporation under the registered names of TOKUSIL® and FINESIL®.

The gel process silica is manufactured by reaction between sodium silicate and sulfuric acid under an acidic condition. In this case, small silica particles are dissolved during aging and re-precipitated so as to bind relatively large primary silica particles. Thus, definite primary particles disappear, and relatively hard flocculated particles having a porous internal structure are formed. This type of silica is commercially available, e.g., from MIZUSAWA INDUSTRIAL CHEMICALS, LTD. under the registered name of MIZUKASIL® or from Grace Japan K.K. under the trade name of SILOJET.

The sol process silica is also referred to as “colloidal silica”, and obtained by thermally aging silica sol produced by metathetic reaction of sodium silicate with an acid or the like or by passing sodium silicate through an ion-exchange resin layer. The type of silica is commercially available, e.g., from Nissan Chemical Industries, Ltd. under the trade name of SNOWTEX.

Examples of the wet process silica to be used in the invention include the precipitation process silica and the gel process silica. The wet process silica generally has an average particle size (average secondary-particle size) of 1 μm or larger. In the invention, it is preferred that such wet process silica undergo a grinding operation until the average particle size thereof reaches 500 nm or less, and preferably 300 nm or less. The lower limit of the average particle size is about 50 nm. The particle sizes of the wet process silica having undergone a grinding operation can be determined using a transmission electron microscope or a laser scattering particle size distribution analyzer as mentioned hereinbefore.

The grinding operation for the wet process silica preferably includes a primary dispersion step in which fine particles of silica are added to and mixed in a dispersion medium (preliminary dispersion) and a secondary dispersion step in which the silica particles in the crude dispersion solution obtained in the primary dispersion step are ground. The preliminary dispersion in the primary dispersion step can be performed, e.g., by usual propeller agitation, agitation with a dentate-blade dispersing device, turbine agitation, homomixer agitation or ultrasonic agitation. As a grinding method for the wet process silica, a wet dispersion method in which the silica dispersed in a dispersion medium is ground mechanically can be used suitably. Examples of a usable wet dispersing machine include a media mill such as a ball mill, a bead mill or a sand grinder, a pressure dispersing machine such as a high-pressure homogenizer or an ultrahigh-pressure homogenizer, an ultrasonic dispersing machine and a thin-film rotary dispersing machine. Of these machines, a media mill such as a bead mill is preferably used.

The average particle size (average secondary-particle size) of the wet process silica is preferably 5 μm or larger. By grinding silica having a relatively large particle size, dispersion in a higher concentration becomes feasible. Although the upper limit of the average particle size of the wet process silica is not particularly limited, the average particle size of the wet process silica is generally 200 μm or less.

Additionally, precipitation process silica is preferred as the wet process silica. As mentioned above, since the secondary particles of the precipitation process silica are gently flocculated particles, the precipitation process silica are suitable for being ground.

The amount of the inorganic fine particles in one ink-receiving sublayer (or in an ink-receiving layer in a case of a single-layered structure) is preferably from 2 to 30 g/m², and more preferably from 3 to 15 g/m². When the amount of the inorganic fine particles is within this range, a porous structure can be obtained easily and ink absorbability and glossiness can be ensured.

Water-Soluble Resin

The ink-receiving layer in the invention includes at least one water-soluble resin, whereby film property may be maintained and high transparency and higher permeability of ink may be obtained.

Examples of the water-soluble resin include polyvinyl alcohol, polyethylene glycol, starch, dextrin, carboxymethylcellulose, and derivatives thereof. Of these, a completely saponified polyvinyl alcohol or a partially saponified polyvinyl alcohol is especially preferred. As the polyvinyl alcohol, partially- or completely-saponified polyvinyl alcohol having a saponification degree of 80% or higher is particularly preferably used. An average polymerization degree of the polyvinyl alcohol is preferably from 500 to 5,000.

The ratio between the inorganic fine particles (p) and the water-soluble resin (b) in an ink-receiving sublayer (or in the ink-receiving layer in a case of a single-layered structure) (p/b; mass ratio) is preferably from 1.5/1 to 12/1, more preferably from 2/1 to 10/1, and particularly preferably from 3/1 to 8/1.

Further, from the viewpoint of smoothly passing an ink from the side of the ink-receiving layer distant from the support to an ink-receiving layer close to the support, it is preferable that the relationship of the mass ratio “b/p” in an ink-receiving sublayer distant from the support is smaller than that in another ink-receiving sublayer closer to the support.

The amount of the water-soluble resin in one ink-receiving sublayer (or in an ink-receiving layer in a case of a single-layered structure) is preferably from 1 to 30 mass %, and particularly preferably from 12 to 25 mass %, with respect to the inorganic fine particles.

Water-Soluble Aluminum Compound

At least one ink-receiving sublayer in the invention further includes at least one water-soluble aluminum compound. The water-soluble aluminum compound may be contained in only one of plural sublayers, or may be contained in two or more sublayers, for example, with different concentrations thereof. By including the water-soluble aluminum compound, bleeding of an image and change in color tone after recording of an image may be suppressed.

The term “water-soluble” or the like means that the compound is dissolved by 1 mass % or more in water at 20° C.

Examples of the water-soluble aluminum compound include: inorganic salts such as aluminum chloride or hydrates thereof, aluminum sulfate or hydrates thereof, and ammonium alum; and basic polyaluminum hydroxide compounds that are inorganic aluminum-containing cationic polymers. Among them, those that can be added stably to a coating solution for forming an ink-receiving layer are preferred, and the basic polyaluminum hydroxide compounds are particularly preferred, from the viewpoints of suppressing the change in color tone after recording and improving the ozone resistance of the dye.

The basic polyaluminum hydroxide compound is a water-soluble polyaluminum hydroxide in which the main constituent thereof is represented by the following Formula 1, Formula 2, or Formula 3 and which contains basic and high-molecular-weight polynuclear condensed ions, such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ Formula 1

[Al(OH)₃]ₙAlCl₃ Formula 2

Alₙ(OH)ₘCl₍₃ₙ₋ₘ₎ 0<m<3n Formula 3

The water-soluble aluminum compound is commercially available from TAIMEI CHEMICALS Co., Ltd. as basic aluminum chloride (trade name: ALFINE 83), from Taki Chemical Co. Ltd. as a water treating agent under the name of aluminum polychloride (PAC), from Asada Chemical Co. Ltd. under the name of polyaluminum hydroxide (Paho), and from Rikengreen Co., Ltd. under the trade name of PURACHEM WT. In addition, other makers also provide water-soluble aluminum compounds with the same purpose, and various grades thereof are available easily.

The amount of the water-soluble aluminum compound in one ink-receiving sublayer (or in an ink-receiving layer in a case of a single-layered structure) is preferably from 0.1 to 20 mass %, more preferably from 1 to 8 mass %, and most preferably from 2 to 4 mass %, with respect to the total solid content in the ink-receiving sublayer. When the amount of the water-soluble aluminum compound is within the range, bleeding and change in color tone of an image can be suppressed and this is also advantageous in view of the improvement of glossiness, water proofness, gas proofness, and light fastness.

In the invention, in addition to the water-soluble aluminum compound, another water-soluble polyvalent metal compound may be used in combination.

Specific examples of the water-soluble polyvalent metal compound include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, ammonium copper chloride (II) dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amide sulfate tetrahydrate, aluminum sulfate, aluminum sulfite, aluminum thiosulfate, polyaluminum chloride, aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zirconium acetate, zirconyl acetate, zirconyl nitrate, basic zirconium carbonate, zirconium hydroxide, zirconium lactate, zirconyl ammonium carbonate, zirconyl potassium carbonate, zirconyl sulfate, zirconium fluoride, zirconium chloride, zirconium chloride octahydrate, zirconium oxychloride, zirconium hydroxychloride, titanium chloride, titanium sulfate, chromium acetate, chromium sulfate, magnesium sulfate, magnesium chloride hexahydrate, magnesium citrate nonahydrate, sodium phosphotungstate, sodium tungsten citrate, 12 tungstophosphate n-hydrate, 12 tungstosilicate 26-hydrate, molybdenum chloride, and 12 molybdophosphate n-hydrate. Among them, water-soluble salts of aluminum or the group IVa elements of the periodical table (such as zirconium, titanium) are particularly preferred.

The term “water-soluble” or the like means herein that the compound is dissolved by 1 mass % or more in water under a normal temperature and a normal pressure.

In particular, water-soluble zirconium compounds (such as zirconium acetate, zirconyl acetate, zirconium chloride, zirconium oxychloride, zirconium hydroxychloride, zirconyl nitrate, basic zirconium carbonate, zirconium hydroxide, zirconium lactate, ammonium zirconyl carbonate, potassium zirconyl carbonate, zirconyl sulfate, or zirconium fluoride compound) are preferred.

Other Components

The ink-receiving layer in the invention may optionally include a cationic polymer, oil droplets, a film hardener, or various other additives, in addition to the components described above.

Cationic Polymer

For the ink-receiving layer in the invention, a cationic polymer is preferably used in the process of dispersing or pulverizing the inorganic fine particles.

The cationic polymer may be a water-soluble cationic polymer having a quaternary ammonium group, phosphonium group, or an acid adduct of primary to ternary amines. Examples of the cationic polymer include polyethyleneimine, polydialkyldiallylamine, polyallylamine, alkylamine epichlorohydrin polycondensate, and cationic polymers disclosed, for example, in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411, and 10-193776, and WO99/64248.

The weight average molecular weight of the cationic polymer is preferably 100,000 or less, more preferably 50,000 or less, and particularly preferably from about 2,000 to about 30,000.

The amount of the cationic polymer in one ink-receiving sublayer (or in an ink-receiving layer in a case of a single-layered structure) is preferably in a range of from 1 to 10 mass % with respect to the inorganic fine particles.

Oil Droplet

The ink-receiving layer in the invention may include various oil droplets. Fragility of a resultant film can be improved by using various oil droplets. Examples of the oil droplets include hydrophobic high-boiling-point organic solvents having a water solubility of 0.01 mass % or less at a room temperature (for example, liquid paraffin, dioctyl phthalate, tricrezyl phosphate, and silicon oil) or polymer particles (for example, particles obtained by polymerizing one or more polymerizable monomers such as styrene, butyl acrylate, divinylbenzene, butyl methacrylate, and hydroxyethyl methacrylate).

The amount of the oil droplet in one ink-receiving sublayer (or in an ink-receiving layer in a case of a single-layered structure) is preferably in a range of from 10 to 50 mass % with respect to the water-soluble resin.

Film Hardener

The ink-receiving layer in the invention may further include a film hardener that cures the water-soluble resin by crosslinking. Specific examples of the film hardener include aldehyde compounds such as formaldehyde and glutaraldehyde, ketone compounds such as diacetyl and chloropentanedione, bis(2-chloroethylurea)-2-hydroxy-4,6-dichloro-1,3,5-triazine, compounds having a reactive halogen disclosed in the specification of U.S. Pat. No. 3,288,775, divinyl sulfone, a compound having a reactive olefin disclosed in the specification of U.S. Pat. No. 3,635,718, an N-methylol compound disclosed in the specification of U.S. Pat. No. 2,732,316, isocyanates disclosed in the specification of U.S. Pat. No. 3,103,437, aziridine compounds disclosed in the specifications of U.S. Pat. Nos. 3,017,280 and 2,983,611, carbodiimide compounds disclosed in the specification of U.S. Pat. No. 3,100,704, epoxy compounds disclosed in the specification of U.S. Pat. No. 3,091,537, halogen carboxyaldehydes such as mucochloric acid, dioxane derivatives such as dihydroxydioxane, and inorganic film hardeners such as chromium alum, zirconium sulfate, boric acid and boric acid salts. One of them may be used alone, or two or more of them may be used in combination. Among them, boric acid or a boric acid salt is preferred.

The amount of the film hardener in one ink-receiving sublayer is preferably from 0.1 to 40 mass % and more preferably from 0.5 to 30 mass %, with respect to the water-soluble resin included in the ink-receiving sublayer.

Various Additives

The ink-receiving layer in the invention may further include at least one of various known additives such as a coloring dye, a coloring pigment, a UV-absorbent, an antioxidant, a pigment dispersant, a defoaming agent, a leveling agent, a preservative agent, a fluorescence brightener, a viscosity stabilizer, and pH regulator.

Further, the ink-receiving layer may further include a thioether compound, a carbohydrazide and a derivative thereof to improve storability after recording.

The carbohydrazide derivative may be either a compound having one or more identical structures in one molecule thereof, or a polymer having identical structures in the main chain and the side chain of the molecule thereof.

Examples of the thioether compound include aromatic thioether compounds in which aromatic groups are bonded on both sides of a sulfur atom, and aliphatic thioether compounds having alkyl groups on both ends having a sulfur atom therebetween. Among them, aliphatic thioether compounds having a hydrophilic group are preferred.

The compounds can be synthesized in accordance with known synthesis methods, or synthesis methods as described in JP-A Nos. 2002-321447 and 2003-48372. For some of the compounds, commercially available chemical products may be used without modification or the like.

The ink-receiving layer in the invention can be formed by coating using a coating solution for forming an ink-receiving layer. In this case, pH of the coating solution for forming the ink receiving layer is preferably in a range of from 3.3 to 6.5, and particularly preferably in a range of from 3.5 to 5.5.

Support

The inkjet recording medium of the invention includes a support. Examples of the support include waterproof supports of plastic resin films made from, for example, a polyester resin such as polyethylene terephthalate, a diacetate resin, a triacetate resin, an acrylic resin, a polycarbonate resin, polyvinyl chloride, a polyimide resin, cellophane, or celluloid, films obtained by adhering paper and a resin film, and polyolefin resin-coated paper in which both sides of base paper are coated with a polyolefin resin.

The thickness of the support is preferably from 50 μm to 300 μm, and more preferably from 80 μm to 260 μm.

Hereinafter, the polyolefin resin-coated paper preferably used as the waterproof substrate in the invention (hereinafter, may be referred to as “polyolefin-resin coated paper”) is described in detail. The polyolefin resin-coated paper has no particular restriction as to a moisture content thereof. From the viewpoint of curling properties, however, the moisture content is preferably in a range of from 5.0 to 9.0%, and more preferably in a range of from 6.0 to 9.0%. The moisture content in a polyolefin resin-coated paper can be measured by any of known moisture-content measurement methods. For instance, an infrared moisture-measuring system, a bone-dry weight measurement method, a permittivity measurement method, or the Karl Fischer's method can be employed.

The base paper of the polyolefin resin-coated paper is not particularly limited. Paper in common use can be used as the base paper, and smooth raw paper as used, e.g., for a photographic substrate is more suitably used. Examples of pulp used as a constituent of the base paper include natural pulp, regenerated pulp, synthetic pulp and a mixture of at least two of these pulp materials. The base paper may further include an additive generally used in paper making. Examples of the additive include a sizing agent, a paper reinforcing agent, a filler, an antistatic agent, a fluorescent whitener and a dye.

Further, the base paper surfaces may be coated with a surface sizing agent, a paper surface reinforcing agent, a fluorescent whitener, a dye, an anchoring agent, or the like.

The thickness of the base paper is not particularly limited. It is preferable that good surface smoothness be given to the base paper by compressing paper, e.g., under pressure applied by calendering during the papermaking or after papermaking. The basis weight of base paper is preferably from 30 to 250 g/m².

Examples of the polyolefin resin with which base paper is coated include an olefin homopolymer such as a low-density polyethylene, a high-density polyethylene, polypropylene, polybutene or polypentene, a copolymer of two or more olefins, such as an ethylene-propylene copolymer, and a mixture thereof. These polyolefin resins have different degrees of densities and melt viscosity indices (melt indices), and one of them may be used alone, or a mixture of two or more thereof may be used.

Further, it is preferable that various additives in combination as appropriate are added in advance to the resin of the polyolefin resin-coated paper. Examples of such additives include a white pigment such as titanium oxide, zinc oxide, talc or calcium carbonate, a fatty acid amide such as stearic acid amide or arachidic acid amide, a metal salt of fatty acid such as zinc stearate, calcium stearate, aluminum stearate or magnesium stearate, an antioxidant such as IRGANOX 1010 or IRGANOX 1076 (registered name, manufactured by Ciba), a blue pigment or dye such as cobalt blue, ultramarine blue, cecilian blue or phthalocyanine blue, a magenta pigment or dye such as cobalt violet, Fast Violet or manganese purple, a fluorescent whitener, and a ultraviolet absorbent.

The polyolefin-coated paper may be mainly made by flow casting of a polyolefin resin in a hot-melt state onto traveling base paper, or the so-called extrusion coating method; as a result, both sides of the base paper are coated with the resin. In addition, it is preferred that, prior to coating the base paper with the resin, activation treatment such as corona discharge treatment or flame treatment be given to the base paper. The suitable thickness of the resin coating is from 5 μm to 50 μm.

The waterproof substrate used in the invention is preferably provided with an undercoat layer on the side where ink-receiving layers are to be applied. The undercoat layer is a layer formed by coating and drying on the surface of a waterproof substrate in advance of providing ink-receiving layers. The undercoat layer includes as a main component a film-formable water-soluble polymer, polymer latex or the like. The main component is preferably a water-soluble polymer, such as gelatin, polyvinyl alcohol, polyvinyl pyrrolidone or water-soluble cellulose, and particularly preferably gelatin. The adhesion amount of such a water-soluble polymer is preferably from 10 to 500 mg/m², and more preferably from 20 to 300 mg/m².

In addition, it is preferred that the undercoat layer further include a surfactant or a hardener. The undercoat layer provided on the substrate can effectively prevent occurrence of cracks during the coating of ink-receiving layers and contribute to uniform coating-surface formation.

Manufacturing Method of Inkjet Recording Medium

A method of manufacturing an inkjet recording medium is described.

The inkjet recording medium of the invention may be prepared by any method so long as the method can form an ink-receiving layer on both surfaces of a support such that the peak of the distribution of the water-soluble aluminum compound is present respectively at the specified depth (position) as described above.

The method of forming the ink-receiving layer on both surfaces of the support includes, for example, a manufacturing method including forming an ink-receiving layer on one side of a support using a method described in detail below and forming an ink-receiving layer on the other side of the support in the same manner, and a manufacturing method including preparing two supports each of which has one side provided with an ink-receiving layer using a method described in detail below and bonding the supports so that the sides on which the ink-receiving layer has not been formed contact each other. In the invention, a manufacturing method preferably includes forming an ink-receiving layer on one side of a support using the method described in detail below and forming an ink-receiving layer on the other side of the support in the same manner.

The method of forming the ink-receiving layer on the support such that the peak of the distribution of the water-soluble aluminum compound is present at a specified depth (position) preferably includes using two or more coating solutions for forming an ink-receiving layer, each including inorganic fine particles and a water-soluble resin and at least one of the coating solutions further including a water-soluble aluminum compound, and layer-coating the two or more coating solutions for forming an ink-receiving layer on a support such that the peak of the distribution of the water-soluble aluminum compound included in the entire coating film formed by the coating is present at a depth (in a region) of from 20% to 60% from the film surface on the side distant from the support in the thickness direction of the layers. In other words, in the method of forming an ink-receiving layer, two or more coating solutions are applied on both sides of a support to form an ink-receiving layer having a multilayered structure (including at least two sublayers, in this case) on each of the both sides of the support.

The term “peak of the distribution of the water-soluble aluminum compound contained in the entire coating film” referred to in the manufacturing method described above is a peak after coating and before drying, which can be determined in the same manner as in the case of the ink-receiving layer after drying described above, for example, based on the coating thickness and the amount of the water-soluble aluminum compound upon coating, and which can be defined with reference to the center in the thickness direction of the coating film having the largest amount of the water-soluble aluminum compound among the layered coating films. In this case, the depth for the peak of the water-soluble aluminum compound in the ink-receiving layer after drying can also be determined by previously determining a relationship between the coating thickness and the amount of the water-soluble aluminum compound upon coating and the layer thickness of the ink-receiving layer and the amount of the water-soluble aluminum compound after drying.

As described above, an ink-receiving layer having a two- or more layer structure is formed by coating such that a larger amount of the water-soluble aluminum compound is present in a region near the center, in the thickness direction, of the ink-receiving layer (entire coating film) than in the vicinity of either end of the entire coating film in the thickness direction of the film; in particular, at a depth (in a region) of from 20 to 60% from the surface of the outermost film most distant from the support in the entire coating film, whereby an inkjet recording material can be obtained in which bronzing is suppressed, bleeding of an image that tends to occur after recording is suppressed, and change in color tone does not occur even when image-recorded surfaces contact each other.

In the invention, it is preferred to use two or more coating solutions for forming an ink-receiving layer and layer-coating the coating solutions. In the layer coating, coating solutions for forming an ink-receiving layer may be applied successively to stack the coating films one by one, or plural coating solutions for forming an ink-receiving layer may be layer-coated at once (simultaneous layer coating). When plural layers that form the ink-receiving layer in the invention are formed by coating them substantially at the same time without an intermediate drying step, characteristics required for the respective layers can be obtained efficiently and this is preferred from the viewpoint of production efficiency. That is, it is considered that when each of the layers is layered in a wet state, permeation of components in each layer to a lower layer is reduced and the composition of the ingredients in each layer can be maintained in a favorable state after drying as well.

The coating solution for forming the ink-receiving layer can be applied by using a known coating apparatus.

For the sequential coating of the layers, a coating method, for example, using a blade coater, an air knife coater, a roll coater, a bar coater, a gravure coater, or a reverse coater is preferred. Further, the simultaneous layer coating is performed using, for example, a slide bead coater, a curtain flow coater, or an extrusion die coater.

In the invention, simultaneous layer coating for multi-layers is preferred.

The method of manufacturing the inkjet recording medium preferably includes drying under conditions in which the film surface temperature of the coating film is lower than 20° C. Specifically, the method preferably includes a drying step in which the film surface temperature becomes lower than 20° C. in the drying process after the coating. Drying may be performed such that the film surface temperature is lower than 20° C. at the beginning of drying, or the film surface temperature is lowered to a temperature lower than 20° C. after lapse of a certain time from the beginning of drying or in the latter stage of drying. In particular, from the viewpoint of obtaining a uniformly coated surface and gap volume (void volume), the drying step in which the film temperature becomes lower than 20° C. is preferably performed in the initial stage of the drying and, in particular, immediately after the commencement of drying. By performing the drying such that the film surface temperature becomes lower than 20° C. in the initial stage of drying (in particular, immediately after commencement of drying), unevenness in the drying can be avoided even for a coating solution having a low viscosity, thereby improving glossiness. When the drying is performed at a high temperature in the initial stage of drying, drying unevenness occurs which reduces the glossiness, particularly when, for example, the viscosity of the coating solution is low.

By providing a drying step in which the film surface temperature is lower than 20° C., the viscosity at the film surface of the coating solution increases and a more uniform state of the coating surface can be obtained. The film surface temperature is preferably 0° C. or higher and lower than 20° C., and more preferably from 5° C. to 15° C. By controlling the film surface temperature to 0° C. or higher, it is possible to suppress excessive increase in the viscosity of the coating solution and prevent formation of unevenness on the surface of the coating film, thereby obtaining higher glossiness.

The film surface temperature is the temperature at the surface of the coating film during drying, which can be measured by a radiation thermometer.

Exemplary embodiments of the invention will be described hereinafter.

(1) An inkjet recording material, including:

a support; and

an ink-receiving layer including inorganic fine particles, a water-soluble resin and a water-soluble aluminum compound and provided on both sides of the support.

(2) The inkjet recording material according to (1), wherein, when the thickness of an ink-receiving layer is regarded as 100%, the water-soluble aluminum compound is distributed such that the peak of the distribution of the water-soluble aluminum compound is present in a region from 20% to 60% from a surface of the ink-receiving layer at a side distant from the support.

(3) The inkjet recording material according to (2), wherein the peak of the distribution of the water-soluble aluminum compound is present in a region from 40% to 55% from the surface of the ink-receiving layer at the side distant from the support.

(4) The inkjet recording material according to (1), wherein each of the ink-receiving layers has a thickness of from 15 μm to 60 μm.

(5) The inkjet recording material according to (1), wherein the inorganic fine particles are vapor phase silica.

(6) The inkjet recording material according to (5), wherein the vapor phase silica has an average primary particle diameter of from 5 nm to 50 nm.

(7) The inkjet recording material according to (5), wherein the vapor phase silica has a BET surface area of from 90 m²/g to 400 m²/g.

(8) The inkjet recording material according to (5), wherein the vapor phase silica has an average secondary particle diameter of 500 nm or less.

(9) The inkjet recording material according to (1), wherein the amount of the inorganic fine particles in the ink-receiving layer is from 2 g/m² to 30 g/m².

(10) The inkjet recording material according to (1), wherein each of the ink-receiving layers includes at least two ink-receiving sublayers.

(11) The inkjet recording material according to (10), wherein each of the ink-receiving sublayers has a thickness of from 5 μm to 25 μm.

(12) The inkjet recording material according to (1), wherein the water-soluble resin is selected from the group consisting of polyvinyl alcohol, polyethylene glycol, starch, dextrin, carboxymethylcellulose, and derivatives thereof.

(13) The inkjet recording material according to (12), wherein the water-soluble resin is a completely-saponified or partially saponified polyvinyl alcohol having a saponification degree of 80% or more.

(14) The inkjet recording material according to (1), wherein the ratio p/b of the inorganic fine particles (p) to the water-soluble resin (b) in the ink-receiving layer is from 1.5/1 to 12/1.

(15) The inkjet recording material according to (1), wherein the amount of the water-soluble resin in the ink-receiving layer is from 10% to 30% by mass with respect to the inorganic fine particles.

(16) The inkjet recording material according to (1), wherein the water-soluble aluminum compound is selected from the group consisting of aluminum chloride or hydrates thereof, aluminum sulfate or hydrates thereof, ammonium alum, and basic polyaluminum hydroxide compounds.

(17) The inkjet recording material according to (1), wherein the amount of the water-soluble aluminum compound in the ink-receiving layer is from 0.1% to 20% by mass with respect to the total solid content in the ink-receiving layer.

(18) A method of manufacturing an inkjet recording material, including:

preparing at least two coating solutions for forming an ink-receiving layer, the at least two coating solutions each including inorganic fine particles and a water-soluble resin, and at least one of the at least two coating solutions further including a water-soluble aluminum compound; and

layer-coating the at least two coating solutions for forming an ink-receiving layer on both sides of a support in such a manner that, when the thickness of an ink-receiving layer is regarded as 100%, the water-soluble aluminum compound is distributed such that the peak of the distribution of the water-soluble aluminum compound is present in a region from 20% to 60% from a surface of the ink-receiving layer at a side distant from the support.

All publications, patent applications, and technical standards mentioned in this specification are herein incorporated by reference to the same extent as if each individual publication, patent application, or technical standard was specifically and individually indicated to be incorporated by reference.

### EXAMPLES

Hereinafter, the present invention is described more specifically by referring to Examples. However, the invention is not limited to the examples unless they defer from the gist of the invention. In the examples, description is to be made mainly for the case of preparing an inkjet recording sheet as an example of the inkjet recording medium. Unless otherwise specified, “part(s)” indicates “part(s) by mass”.

### Example 1

### Preparation of Support

A 1:1 mixture of bleached hardwood kraft pulp (LBKP) and bleached softwood sulfite pulp (NBSP) was beaten to 300 ml of Canadian Standard Freeness to prepare a pulp slurry. To the pulp slurry, 0.5 mass % of an alkyl ketene dimmer as a seizing agent, 1.0 mass % of a polyacryl amide as a paper reinforcing agent, 2.0 mass % of a cationized starch, 0.5 mass % of a polyamide epichlorohydrin resin, all of which amounts are expressed with respect to the pulp, were added, and the resultant mixture was diluted with water into 1 mass % slurry. The slurry was processed into paper by a fourdrinier paper machine to obtain paper having a weight basis of 170 g/m², and the paper was dried and controlled for moisture to form a base paper for polyolefin resin-coated paper. A polyethylene resin composition in which 10 mass % of anatase titanium was uniformly dispersed in a resin made of 100% low density polyethylene having a density of 0.918 g/cm³ was melted at 320° C. and extrusion-coated to a thickness of 35 μm for 200 m/min onto both sides of the prepared base paper to extrusion-coat the base paper by using a cooling roll having a finely roughened surface.

After applying an RF corona discharging treatment to the surface of the thus-obtained polyolefin resin-coated paper, a subbing layer having the following composition was formed such that at the amount of gelatin became 50 mg/m², to thereby prepare a support having a subbing layer formed on one side thereof.

Subbing Layer

| | |
|---|---|
| Lime-treated gelatin: | 100 parts |
| 2-ethylhexyl sulfosuccinate salt: | 2 parts |
| Chromium alum: | 10 parts |

Manufacture of Inkjet Recording Sheet

A coating solution for a first ink-receiving layer (1) having the following composition was prepared as a coating solution for forming a lower layer (first ink-receiving sublayer) adjacent with the support, a coating solution for a second ink-receiving layer (1) having the following composition was prepared as a coating solution for forming an intermediate layer (second ink-receiving sublayer) on the first ink-receiving layer, and a coating solution for a third ink-receiving sublayer (1) having the following composition was prepared as a coating solution for forming an uppermost layer (third ink-receiving layer) on the second ink-receiving layer. The coating solution for a first ink-receiving sublayer (1), the coating solution for a second ink-receiving sublayer (1), and the coating solution for a third ink-receiving sublayer (1) were layer-coated simultaneously on the subbing layer in this order using a slide bead coater. The coating amounts of the coating solutions are shown in the Table 1.

After the coating, the sublayers were cooled at 10° C. for 20 sec so that the film surface temperature became 15° C., and then a heating air at 30 to 55° C. was blown to conduct set-drying, to thereby form a porous ink-receiving layer.

Then, another subbing layer was disposed, in the same manner as described above, on the side of the support opposite to the side on which the ink-receiving layer had been formed. Further, ink-receiving layer (ink-receiving sublayers) was formed on the thus-formed subbing layer in the same manner as described above, to thereby form an inkjet recording sheet having the first ink-receiving layer, the second ink-receiving layer and the third ink-receiving layer stacked on both sides of the support.

Preparation of Liquid Dispersion 1 of Vapor Phase Silica

A dimethyldiallyl ammonium chloride homopolymer was added to a mixed solution of water and a modified ethanol as a dispersing medium, a vapor phase silica was further added, and they were preliminarily dispersed to obtain a crude liquid dispersion. Then, the crude liquid dispersion was treated twice with a high pressure homogenizer to prepare a liquid dispersion 1 of a vapor phase silica at a concentration of 20 mass %. The average particle diameter of the vapor phase silica was 100 nm.

Composition

| | |
|---|---|
| Water: | 430 parts |
| Modified ethanol: | 22 parts |
| Dimethyldiallyl ammonium chloride homopolymer | 3 parts |
| (SHAROLL DC902P (average molecular weight: 9,000), | |
| manufactured by Dai-Ichi Kogyo Seiyaku Co., Ltd.: cationic | |
| polymer): | |
| Vapor phase silica (average primary particle diameter: 7 nm, | 100 parts |
| specific surface area according to BET method: 300 m²/g): | |

Coating Solution for First Ink-Receiving Sublayer (1)

Components of the following composition were mixed to prepare a coating solution for first ink-receiving sublayer (1).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Surfactant (SWANOL AM-2150, betaine | 0.1 | parts |
| surfactant, manufactured by Nihon | | |
| Surfactant Kogyo K.K.): | | |

Coating Solution for Second Ink-Receiving Sublayer 1

Components of the following composition were mixed to prepare a coating solution for second ink-receiving sublayer (1).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE | 3 | parts |
| 83, manufactured by Daimei Chemical | | |
| Industry Co.): | | |
| Surfactant (SWANOL AM-2150, betaine | 0.2 | parts |
| surfactant, manufactured by Nihon | | |
| Surfactant Kogyo K.K.): | | |

Coating Solution for Third Ink-Receiving Sublayer (1)

Components of -the following composition were mixed to prepare a coating solution for third ink-receiving sublayer (1).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Surfactant (SWANOL AM-2150, betaine | 0.3 | parts |
| surfactant, manufactured by Nihon | | |
| Surfactant Kogyo K.K.): | | |

### Example 2

An inkjet recording sheet was manufactured in the same manner as in Example 1 except that the coating solution for a third ink-receiving sublayer (1) was replaced with the following coating solution for a third ink-receiving sublayer (2), and the coating solution for second ink-receiving sublayer (1) was replaced with the following coating solution for a second ink-receiving sublayer (2).

Coating Solution for Third Ink-Receiving Sublayer (2)

Components of the following composition were mixed to prepare a coating solution for a third ink-receiving sublayer (2).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 0.6 | parts |
| manufactured by Daimei Chemical | | |
| Industry Co.): | | |
| Surfactant (SWANOL AM-2150, betaine | 0.3 | parts |
| surfactant, manufactured by Nihon | | |
| Surfactant Kogyo K.K.): | | |

Coating Solution for Second Ink-Receiving Sublayer (2)

Components of the following composition were mixed to prepare a coating solution for a second ink-receiving sublayer (2).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 2.4 | parts |
| manufactured by Daimei Chemical Industry | | |
| Co.): | | |
| Surfactant (SWANOL AM-2150, betaine | 0.2 | parts |
| surfactant, manufactured by Nihon | | |
| Surfactant Kogyo K.K.): | | |

### Example 3

An inkjet recording sheet was manufactured in the same manner as in Example 1 except that the coating solution for third ink-receiving sublayer (1) was replaced with the following coating solution for third ink-receiving sublayer (3), and the coating solution for second ink-receiving sublayer (1) was replaced with the following coating solution for second ink-receiving sublayer (3).

Coating Solution for Third Ink-Receiving Sublayer (3)

Components of the following composition were mixed to prepare a coating solution for third ink-receiving sublayer (3).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 1.2 | parts |
| manufactured by Daimei Chemical Industry | | |
| Co.): | | |
| Surfactant (SWANOL AM-2150, betaine | 0.1 | parts |
| surfactant, manufactured by Nihon | | |
| Surfactant Kogyo K.K.): | | |

Coating Solution for Second Ink-Receiving Sublayer (3)

Components of the following composition were mixed to prepare a coating solution for second ink-receiving sublayer (3).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 1.8 | parts |
| manufactured by Daimei Chemical Industry | | |
| Co.): | | |
| Surfactant (SWANOL AM-2150, betaine | 0.2 | parts |
| surfactant, manufactured by Nihon | | |
| Surfactant Kogyo K.K.): | | |

### Example 4

An inkjet recording sheet was manufactured in the same manner as in Example 1 except that the coating solution for third ink-receiving sublayer (1) was replaced with the following coating solution for third ink-receiving sublayer (4), the coating solution for second ink-receiving sublayer (1) was replaced with the following coating solution for second ink-receiving sublayer (4), the coating amount of the coating solution for third ink-receiving sublayer (4) was changed to 12 g/m², and the coating amount of the coating solution for second ink-receiving sublayer (4) was changed to 6 g/m².

Coating Solution for Third Ink-Receiving Sublayer (4)

Components of the following composition were mixed to prepare a coating solution for third ink-receiving sublayer (4).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 3.0 | parts |
| manufactured by Daimei Chemical Industry | | |
| Co.): | | |
| Surfactant (SWANOL AM-2150, betaine | 0.1 | parts |
| surfactant, manufactured by Nihon | | |
| Surfactant Kogyo K.K.): | | |

Coating Solution for Second Ink-Receiving Sublayer (4)

Components of the following composition were mixed to prepare a coating solution for second ink-receiving sublayer (4).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Surfactant (SWANOL AM-2150, betaine | 0.2 | parts |
| surfactant, manufactured by Nihon | | |
| Surfactant Kogyo K.K.): | | |

### Example 5

An inkjet recording sheet was manufactured in the same manner as in Example 1 except that the coating solution for first ink-receiving sublayer (1) and the coating solution for third ink-receiving sublayer (1) were not applied by coating, and the coating amount of the coating solution for second ink-receiving sublayer (1) was changed to 20 g/m².

### Example 6

An inkjet recording sheet was manufactured in the same manner as in Example 1 except that the coating solution for third ink-receiving sublayer (1) was replaced with the coating solution for third ink-receiving sublayer (4), the coating solution for second ink-receiving sublayer (1) was replaced with the coating solution for second ink-receiving sublayer (4), the coating amount of the coating solution for third ink-receiving sublayer (4) was changed to 4 g/m², the coating amount of the coating solution for second ink-receiving sublayer (4) was changed to 8 g/m², and the coating amount of coating solution for first ink-receiving sublayer (1) was changed to 8 g/m².

### Example 7

An inkjet recording sheet was manufactured in the same manner as in Example 1 except that the coating solution for second ink-receiving sublayer (1) was replaced with the following coating solution for second ink-receiving sublayer (5), the coating solution for first ink-receiving sublayer (1) was replaced with the coating solution for first ink-receiving sublayer (5), the coating amount of the coating solution for third ink-receiving sublayer (1) was set to be 8 g/m², the coating amount of the coating solution for second ink-receiving sublayer (5) was set to be 6 g/m², and the coating amount of coating solution for first ink-receiving sublayer (5) was set to be 6 g/m².

Coating Solution for Second Ink-Receiving Sublayer (5)

Components of the following composition were mixed to prepare a coating solution for second ink-receiving sublayer (5).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 1.5 | parts |
| manufactured by Daimei Chemical Industry | | |
| Co.): | | |
| Surfactant (SWANOL AM-2150, betaine | 0.2 | parts |
| surfactant, manufactured by Nihon | | |
| Surfactant Kogyo K.K): | | |

Coating Solution for First Ink-Receiving Sublayer (5)

Components of the following composition were mixed to prepare a coating solution for first ink-receiving sublayer (5).

Composition

| | | |
|---|---|---|
| Vapor phase silica liquid dispersion 1: | 100 | parts (solid content) |
| Boric acid: | 3 | parts |
| Polyvinyl alcohol (saponification degree: | 22 | parts |
| 88%, average polymerization degree: 3500): | | |
| Basic polyaluminum hydroxide (ALFINE 83, | 1.5 | parts |
| manufactured by Daimei Chemical Industry | | |
| Co.): | | |
| Surfactant (SWANOL AM-2150, betaine | 0.2 | parts |
| surfactant, manufactured by Nihon | | |
| Surfactant Kogyo K.K.): | | |

### Comparative Example 1

An inkjet recording sheet was manufactured in the same manner as in Example 1 except that the coating solution for first ink-receiving sublayer (1) and the coating solution for second ink-receiving sublayer (1) were not applied by coating, and the coating amount of the coating solution for third ink-receiving sublayer (1) was changed to 20 g/m².

Evaluation

For the inkjet recording sheets manufactured in the examples and the comparative examples, the following evaluation was performed. The results of the evaluation are shown in Table 1 shown below.

1. Measurement of Al Peak

Distribution of the amount of aluminum (Al) in the entire ink-receiving layer (including the first ink-receiving sublayer, the second ink-receiving sublayer layer, and the third ink-receiving sublayer), and the peak of the distribution of the amount of Al were measured as described below using an SEM-EDX apparatus.

The inkjet recording sheets were respectively sliced using a diamond knife ULTRA-CUT UCT (manufactured by Leica Co.) to produce cross-sectional specimens of the ink-receiving layers. The specimens were cut to an appropriate size, fixed to a specimen table, and coated with platinum by sputtering to a thickness of about 3 nm, thereby providing samples. As the SEM-EDX apparatus, a JSM-6700 manufactured by JOEL Ltd. and Genesis manufactured by EDAX K.K. were used. First, the sample was put in the apparatus, and the cross section of the sample was observed by SEM at an acceleration voltage of 20 kV under a magnification factor of 1500×. Electron beams were irradiated over a rectangular region (L μm×70 μm) having a depth (L μm) from the uppermost surface to the contact face between the first ink-receiving layer and the support in the direction of the thickness of the ink-receiving layer, and a 70 μm length in the direction parallel to the support on an SEM image, and X-rays generated from the region were scanned and measured. In the measurement, the amount of the electron beam current was controlled to a predetermined value, X-rays were scanned for 100 sec, and the distribution of the amount of aluminum (Al) and the peak thereof were determined based on the obtained spectra using analysis software appended to the apparatus.

In this case, for the peak in the distribution of the water-soluble aluminum compound contained in the entire ink-receiving layer, the distance from the exposed surface of the third ink-receiving sublayer to a position at one-half the thickness of the ink-receiving sublayer having the highest Al concentration in the direction of the thickness of the entire ink-receiving layer including all three sublayers was defined as the depth of the peak from the uppermost surface of the entire ink-receiving layer.

In Example 5 in which the ink-receiving layer has a single layer, the intermediate position in the direction of the thickness of the ink-receiving layer was defined as the depth of the peak from the outermost surface of the entire ink-receiving layer.

2. Change in Color Tone (Change of Color)

A gray solid image was recorded on the ink-receiving layer (third ink-receiving sublayer) of each of the inkjet recording sheets using an inkjet printer A820 (manufactured by Seiko-Epson Co.). In this case, gradation of image data was controlled such that the gray density measured by Gretag Spectrolino SPM-50 (manufactured by GretagMacbeth Co; view angle: 2°, light source: D50, with no filter) was 1.7.

The inkjet recording sheets were left for one day under conditions where they were stacked such that surfaces on which the solid images had been recorded were in contact with each other. Immediately after printing (within 3 min after printing) and after one day in the stacked state after printing, L*a*b* were measured for each of the gray solid images by using a spectrophotometer, Spectrolino (manufactured by GretagMacbeth Co.) under conditions of a view angle of 2°, using a light source of F8 and with no filter, color differences (ΔE) were determined based on respective measured values, and the color differences were used as the index for evaluating the change in color tone. Evaluation was performed in accordance with the following evaluation criteria based on the value of the color difference.

### Evaluation Criteria

A: ΔE<2; hardly any change in color tone was observed.
B: 2≦ΔE<4; change in color tone was observed but was not particularly conspicuous.
C: ΔE≧7; change in color tone was conspicuous.

3. Bronzing

After each of the inkjet recording sheets were left in ambient conditions of 35° C. and 80% RH for 16 hrs with the temperature and humidity controlled, a solid image of blue color was recorded under the same conditions using an inkjet printer PMG-800 (manufactured by Seiko-Epson Co.). Then, recorded images were observed with the naked eye, and bronzing was evaluated in accordance with the following evaluation criteria.

### Evaluation Criteria

A: Reddish bronzy metallic gloss was not observed.
B: Reddish bronzy metallic gloss was generated in places.
C: Reddish bronzy metallic gloss was generated over the entire surface.

4. Image Bleeding

A lattice-like linear pattern (line width: 0.28 mm) in which a magenta ink and a black ink were adjacent to each other was recorded on each of the inkjet recording sheets using an inkjet printer PMG-800 (manufactured by Seiko-Epson Co.). After storing the recorded samples in ambient conditions of a temperature of 23° C. and at a humidity of 90% RH for 14 days, bleeding of black lines was evaluated with the naked eye in accordance with the following evaluation criteria.

### Evaluation Criteria

A: Bleeding was not observed.
B: Some bleeding was observed but this was within a practically allowable range.
C: Remarkable bleeding was observed, and this was not within a practically allowable range.

TABLE 1

| | | | | | | | Aluminum | | | |
|---|---|---|---|---|---|---|---|---|---|---|
| | Upper layer | | Intermediate layer | | Lower layer | | peak | | | |
| | | Water soluble | | Water soluble | | Water soluble | depth | Change | | |
| | Coating | aluminum | Coating | aluminum | Coating | aluminum | (in entire | in color | | Image |
| | amount | compound | amount | compound | amount | compound | layer) | tone | Bronzing | bleeding |
| Example 1 | 6 g/m² | none | 12 g/m² | present | 6 g/m² | none | 50% | B | B | C |
| | | | | (entire | | | | | | |
| | | | | amount × 1) | | | | | | |
| Example 2 | 6 g/m² | present | 12 g/m² | present | 6 g/m² | none | 44% | A | B | B |
| | | (entire | | (entire | | | | | | |
| | | amount × 0.2) | | amount × 0.8) | | | | | | |
| Example 3 | 6 g/m² | present | 12 g/m² | present | 6 g/m² | none | 31% | B | C | B |
| | | (entire | | (entire | | | | | | |
| | | amount × 0.4) | | amount × 0.6) | | | | | | |
| Example 4 | 12 g/m² | present | 6 g/m² | none | 6 g/m² | none | 25% | B | C | B |
| | | (entire | | | | | | | | |
| | | amount × 1) | | | | | | | | |
| Example 5 | Single layer 20 g/m² (water soluble aluminum compound: present) | | | | | | With no | B | C | B |
| | | | | | | | peak | | | |
| Example 6 | 4 g/m² | present | 8 g/m² | none | 8 g/m² | none | 10% | B | C | C |
| | | (entire | | | | | | | | |
| | | amount × 1) | | | | | | | | |
| Example 7 | 8 g/m² | none | 6 g/m² | present | 6 g/m² | present | 70% | B | B | C |
| | | | | (entire | | (entire | | | | |
| | | | | amount × 0.5) | | amount × 0.5 | | | | |

| | | | | | |
|---|---|---|---|---|---|
| Comp. | Single layer 20 g/m² (water soluble aluminum compound: none) | With no | D | B | D |
| Example 1 | | peak | | | |

*1: “Entire amount × z” in the column for water-soluble aluminum compound represents “entire amount of a water-soluble aluminum compound included in three layers × proportion z thereof in three layers”

As shown in the Table 1, in the inkjet recording medium of the invention, generation of change in color tone (change of color) of an image could be suppressed even in a case where the image-recorded surfaces are in contact with each other.

Further, generation of bleeding in the image was suppressed effectively with no generation of bronzing. In contrast, generation of change in color tone of images was not prevented in the comparative examples.

What is claimed is:

1. An inkjet recording material, comprising:
a support; and
an ink-receiving layer comprising inorganic fine particles, a water-soluble resin and a water-soluble aluminum compound and provided on both sides of the support.

2. The inkjet recording material according to claim 1, wherein, when the thickness of an ink-receiving layer is regarded as 100%, the water-soluble aluminum compound is distributed such that the peak of the distribution of the water-soluble aluminum compound is present in a region from 20% to 60% from a surface of the ink-receiving layer at a side distant from the support.

3. The inkjet recording material according to claim 2, wherein the peak of the distribution of the water-soluble aluminum compound is present in a region from 40% to 55% from the surface of the ink-receiving layer at the side distant from the support.

4. The inkjet recording material according to claim 1, wherein each of the ink-receiving layers has a thickness of from 15 μm to 60 μm.

5. The inkjet recording material according to claim 1, wherein the inorganic fine particles comprise vapor phase silica.

6. The inkjet recording material according to claim 5, wherein the vapor phase silica has an average primary particle diameter of from 5 nm to 50 nm.

7. The inkjet recording material according to claim 5, wherein the vapor phase silica has a BET surface area of from 90 m²/g to 400 m²/g.

8. The inkjet recording material according to claim 5, wherein the vapor phase silica has an average secondary particle diameter of 500 nm or less.

9. The inkjet recording material according to claim 1, wherein the amount of the inorganic fine particles in the ink-receiving layer is from 2 g/m² to 30 g/m².

10. The inkjet recording material according to claim 1, wherein each of the ink-receiving layers comprises at least two ink-receiving sublayers.

11. The inkjet recording material according to claim 10, wherein each of the ink-receiving sublayers has a thickness of from 5 μm to 25 μm.

12. The inkjet recording material according to claim 1, wherein the water-soluble resin is selected from the group consisting of polyvinyl alcohol, polyethylene glycol, starch, dextrin, carboxymethylcellulose, and derivatives thereof.

13. The inkjet recording material according to claim 12, wherein the water-soluble resin comprises a completely-saponified or partially saponified polyvinyl alcohol having a saponification degree of 80% or more.

14. The inkjet recording material according to claim 1, wherein the ratio p/b of the inorganic fine particles (p) to the water-soluble resin (b) in the ink-receiving layer is from 1.5/1 to 12/1.

15. The inkjet recording material according to claim 1, wherein the amount of the water-soluble resin in the ink-receiving layer is from 10% to 30% by mass with respect to the inorganic fine particles.

16. The inkjet recording material according to claim 1, wherein the water-soluble aluminum compound is selected from the group consisting of aluminum chloride or hydrates thereof, aluminum sulfate or hydrates thereof, ammonium alum, and basic polyaluminum hydroxide compounds.

17. The inkjet recording material according to claim 1, wherein the amount of the water-soluble aluminum compound in the ink-receiving layer is from 0.1% to 20% by mass with respect to the total solid content in the ink-receiving layer.

18. A method of manufacturing an inkjet recording material, comprising:
preparing at least two coating solutions for forming an ink-receiving layer, the at least two coating solutions each comprising inorganic fine particles and a water-soluble resin, and at least one of the at least two coating solutions further comprising a water-soluble aluminum compound; and
layer-coating the at least two coating solutions for forming an ink-receiving layer on both sides of a support in such a manner that, when the thickness of an ink-receiving layer is regarded as 100%, the water-soluble aluminum compound is distributed such that the peak of the distribution of the water-soluble aluminum compound is present in a region from 20% to 60% from a surface of the ink-receiving layer at a side distant from the support.
